(19) United States
(12) Patent Application Publication
(10) Pub. No.: US 2023/0229937 A1
(43) Pub. Date: Jul. 20, 2023

(54) AI TRAINING DATA CREATION SUPPORT SYSTEM, AI TRAINING DATA CREATION SUPPORT METHOD, AND AI TRAINING DATA CREATION SUPPORT PROGRAM

(71) Applicant: Hitachi, Ltd., Tokyo (JP)

(72) Inventors: Mika Takata, Tokyo (JP); Toshihiko Kashiyama, Tokyo (JP)

(73) Assignee: Hitachi, Ltd., Tokyo (JP)

(21) Appl. No.: 18/069,322

(22) Filed: Dec. 21, 2022

(30) Foreign Application Priority Data
Jan. 14, 2022 (JP) 2022-004476

(51) Int. Cl. G06N 5/022

(52) U.S. Cl. CPC G06N 5/022

(57) ABSTRACT

To efficiently collect training data for training an AI model, an input of a training profile is received that includes item values corresponding to a plurality of data items, including analysis target data to be analyzed by the AI model and information on the model type. A first query is acquired to extract training data from a training database. The number of pieces of first training data to be extracted from the training database is calculated. The required number of pieces of the training data to train the AI model is calculated using the information on the model type. Whether the number of pieces of the first training data is equal to or greater than the required number is determined. When the determined number of pieces of the first training data is less than the required number, a supplementary query for extracting the training data is generated.

### BACKGROUND OF THE INVENTION

### 1. Field of the Invention

The present disclosure relates to an AI training data creation support system, an AI training data creation support method, and an AI training data creation support program for extracting and collecting, from at least one training database, training data for training an AI model.

### 2. Description of the Related Art

A technique for obtaining desired information from enormous information that can be acquired via the Internet has been disclosed. For example, in a technique disclosed in JP2005-209210A (PTL 1), a sub-web including a list of paths of sites on the Internet, which are weighted based on correlation with a topic in which a user is interested or a characteristic of the user, is created. Then, a search engine uses the sub-web for site search of the Internet, so that it is possible to easily execute focused site search of the Internet. Therefore, when the technique disclosed in PTL 1 is used, it is possible to collect information on sites on the Internet that are related to the interest of the user and the characteristic of the user by searching using the search engine.

However, even if information on sites of the Internet, which are related to a characteristic of a user, is collected using the technique disclosed in PTL 1, it may not be easy to extract and collect training data for training an AI model, which includes information related to a plurality of specific data items, from a database.

In particular, a health care AI model used for analyzing or predicting a health condition of an individual or a group is expected to perform important analysis related to health of a person, but training data may not be easily collected depending on analysis content to be analyzed by the health care AI model. For example, in a case where the analysis content is a lung cancer risk (likeliness of onset) of a patient of a rare disease A, since there are very few people who suffered from the rare disease A and further developed lung cancer in the past, it is difficult to collect training data. In addition, in a case where high accuracy is required for an analysis result of the health care AI model, it may be difficult to collect training data.

### SUMMARY OF THE INVENTION

An object of the present invention is to provide an AI training data creation support system, an AI training data creation support method, and an AI training data creation support program capable of efficiently collecting training data for training an AI model.

An AI training data creation support system according to an aspect of the present invention disclosed in the present application is an AI training data creation support system for extracting and collecting training data for training an AI model from at least one training database, the AI training data creation support system including: a storage device configured to store at least one program; a processor configured to execute the program stored in the storage device; and an input device configured to receive an input from a user. The processor executes the program to receive an input of a training profile that includes item values corresponding to a plurality of data items and includes analysis target data to be analyzed by the AI model and information on a type of the AI model, acquire a first query used for extracting the training data, calculate, by using the training database, the number of pieces of first training data to be extracted from the training database according to the first query, calculate the required number of pieces of the training data required to train the AI model, by using the information on the type of the AI model included in the training profile, determine whether the number of pieces of the first training data is equal to or greater than the required number, and generate, based on the training profile, a supplementary query used for extracting the training data when the number of pieces of the first training data is determined to be less than the required number.

According to the present invention, training data for training an AI model can be efficiently collected.

### BRIEF DESCRIPTION OF THE DRAWINGS

FIG. 1 illustrates an example of a functional block diagram of an AI training data creation support system according to a first embodiment.

FIG. 2 illustrates an example of a hardware configuration diagram of the AI training data creation support system according to the first embodiment.

FIG. 3 illustrates an example of a personal profile and a first query.

FIG. 4 illustrates an example of a setting condition database and a setting condition table stored in the setting condition database.

FIG. 5 illustrates an example of a search condition database.

FIG. 6 illustrates an example of an algorithm required number table.

FIG. 7 illustrates an example of an analysis content required number table.

FIG. 8 is an explanatory diagram illustrating an example of a personal profile input screen displayed on a client device in order for a user to input a personal profile and a first query.

FIG. 9 is an explanatory diagram illustrating an example of a query input screen displayed on the client device in order for the user to input the first query.

FIG. 10 is an explanatory diagram illustrating another example of the query input screen displayed on the client device in order for the user to input the first query.

FIG. 11 is a flowchart illustrating an example of training data acquisition processing according to the first embodiment.

FIG. 12 is a flowchart illustrating an example of processing of a supplementary query generation subroutine according to the first embodiment.

FIG. 13 is a diagram illustrating a method of generating a second supplementary query.

FIG. 14 is an explanatory diagram illustrating an example of a supplementary query display screen displayed on a display of the client device in order to present, to the user, supplementary queries and the corresponding numbers of pieces of supplementary data registered in a supplementary query list.

FIG. 15 is a flowchart illustrating an example of processing of a supplementary query generation subroutine according to a second embodiment.

FIG. 16 is a flowchart illustrating an example of training data acquisition processing according to a third embodiment.

### DESCRIPTION OF EMBODIMENTS

Hereinafter, embodiments will be described with reference to the drawings. The embodiments are examples for describing the invention, and omission and simplification are appropriately made for a clarified description. The present invention is not limited to the embodiments, and all application examples that match the concept of the present invention are covered by the technical scope of the present invention.

In the drawings and the following description, the same reference signs may be assigned to the same portions or portions having the same functions, different subscripts may be given to the same reference sign, or subscripts may be omitted. Unless otherwise specified, each component may be either plural or singular.

In order to facilitate understanding of the invention, a position, a size, a shape, a range, and the like of each component illustrated in the drawings may not represent an actual position, size, shape, range, or the like. Therefore, the present invention is not necessarily limited to the position, size, shape, range, or the like illustrated in the drawings.

In the following description, although various types of information may be described in forms such as “table”, “list” and “queue”, the various types of information may be expressed by other data structures. In addition, in order to indicate that the various types of information do not depend on a data structure, a “table” or the like may be referred to as “management information”. When describing identification information, expressions such as “identification information”, “identifier”, “name”, “ID”, and “number” are used, and these expressions may be replaced with one another.

In addition, processing may be described with a sentence whose subject is a “program” or a “functional unit”. The program or the functional unit is implemented by a processor such as a microprocessor (MP), a central processing unit (CPU), or a graphics processing unit (GPU), which is a processing unit or an arithmetic unit, and performs predetermined processing. The processor performs processing while using a storage resource (for example, a memory) and a communication interface device (for example, a communication port). Therefore, a subject of a sentence whose subject is a “program” or a “functional unit” may be replaced with a processor, a processing unit, or an arithmetic unit. In addition, an actor of processing performed by executing a program may be a processor, an arithmetic unit, or a processing unit, may be a controller, a device, a system, a computer, or a node having a processor, or may be a dedicated circuit that performs specific processing. Here, the dedicated circuit refers to, for example, a field programmable gate array (FPGA), an application-specific integrated circuit (ASIC), and a complex programmable logic device (CPLD).

A program may be installed on a computer from a program source. The program source may be, for example, a program distribution server or a storage medium readable by a computer. When the program source is a program distribution server, the program distribution server may include a processor and a storage resource that stores a program to be distributed, and the processor of the program distribution server may distribute the program to be distributed to another computer. Further, two or more programs may be implemented as one program, or one program may be implemented as two or more programs.

### First Embodiment

An AI training data creation support system 1 extracts and collects, from at least one training database, training data for training an AI model. The AI model after training analyzes analysis target data. An AI model to be trained may be, for example, a traffic AI model (such as an optimal route prediction model) in transportation, an industrial AI model (such as a failure diagnosis estimation model of a device) related to manufacturing of a product, or a health care AI model related to medical care.

Hereinafter, as an example, an AI model to be trained is set as a health care AI model used for analyzing or predicting a health condition of an individual or a group, and analysis target data is set as personal information including information on a health condition of an individual. Accordingly, since training data can be easily collected, the AI training data creation support system 1 can collect the training data, without many people referring to personal information and considering a collection method of the training data. Therefore, by collecting training data for the health care AI model, the AI training data creation support system 1 can collect the training data while protecting privacy of an analysis target person. Note that the personal information may include information such as a diagnosis history included in a medical chart, and gene information. The training data to be collected is appropriately changed according to an AI model to be trained. For example, in a case where an AI model to be trained is a failure diagnosis estimation model related to manufacturing of a product, the training data to be collected is, for example, data in which information on characteristics of a manufacturing device and a failure state are associated with each other.

### System Configuration

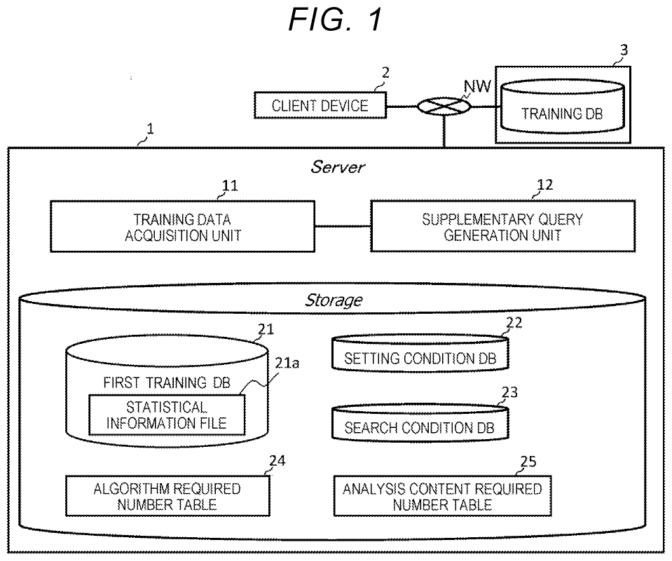

FIG. 1 illustrates an example of a functional block diagram of the AI training data creation support system 1 according to a first embodiment. As illustrated in FIG. 1, the AI training data creation support system 1 is connected to a client device 2 and an external training database server 3 via a network NW.

The client device 2 can transmit personal information (analysis target data) to be analyzed by the AI model and input by a user of the client device 2, a first query for extracting training data from a training database, and the like to the AI training data creation support system 1. In addition, the client device 2 includes a device that displays information, such as a display, and can display information to the user.

The external training database server 3 includes an external training database that is a type of training database storing training data for training the AI model. The AI training data creation support system 1 can extract training data from the external training database server 3 by using a query.

The network NW may be a wired network or a wireless network. The communication network NW may be a global network such as the Internet or a local area network (LAN).

As illustrated in FIG. 1, the AI training data creation support system 1 includes a training data acquisition unit 11 and a supplementary query generation unit 12. In addition, the AI training data creation support system 1 stores a first training database 21, a setting condition database 22, a search condition database 23, an algorithm required number table 24, and an analysis content required number table 25.

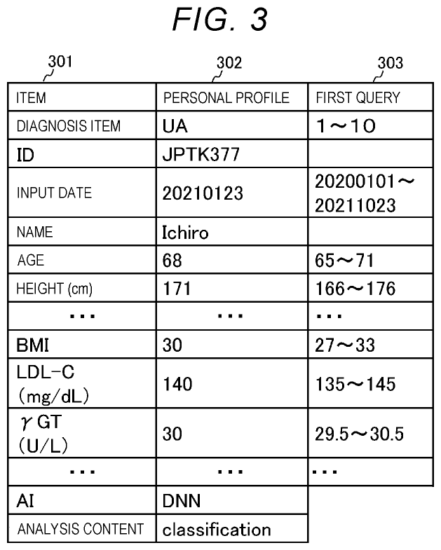

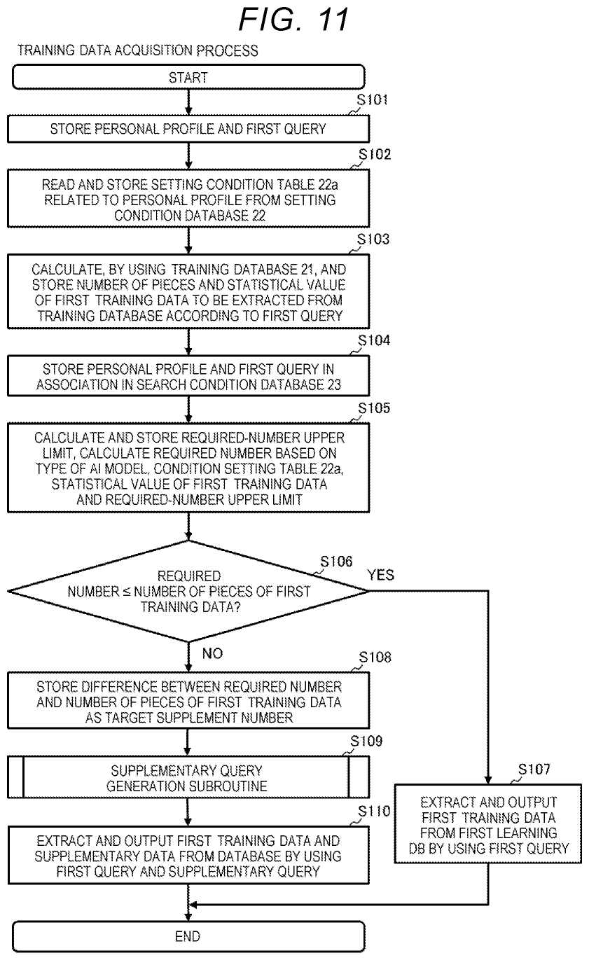

The training data acquisition unit 11 receives an input of a personal profile (training profile) from the user, which will be described in detail later with reference to the flowchart in FIG. 11. Although details will be described with reference to FIG. 3, the personal profile includes item values corresponding to a plurality of data items, and includes personal information (analysis target data) to be analyzed by the AI model to be trained and information on a type of the AI model (an algorithm and analysis content of the AI model).

In addition, the training data acquisition unit 11 acquires a first query (see FIG. 3) used for extraction of training data. The training data acquisition unit 11 uses a training database to calculate the number of pieces of first training data to be extracted from the training database at the first query. The training data acquisition unit 11 uses the information on the type of the AI model included in the training profile to calculate the required number of pieces of training data required to train the AI model. The training data acquisition unit 11 determines whether the number of pieces of the first training data is equal to or greater than the required number. When the number of pieces of the first training data is determined to be equal to or greater than the required number, the training data acquisition unit 11 extracts the first training data from the training database at the first query and outputs the extracted first training data. When the number of pieces of the first training data is determined to be less than the required number, the training data acquisition unit 11 causes the supplementary query generation unit 12 to generate a supplementary query based on the training profile, receives the supplementary query generated by the supplementary query generation unit 12, extracts supplementary data from the training database at the received supplementary query and outputs the extracted supplementary data, and extracts the first training data from the training database and outputs the extracted first training data.

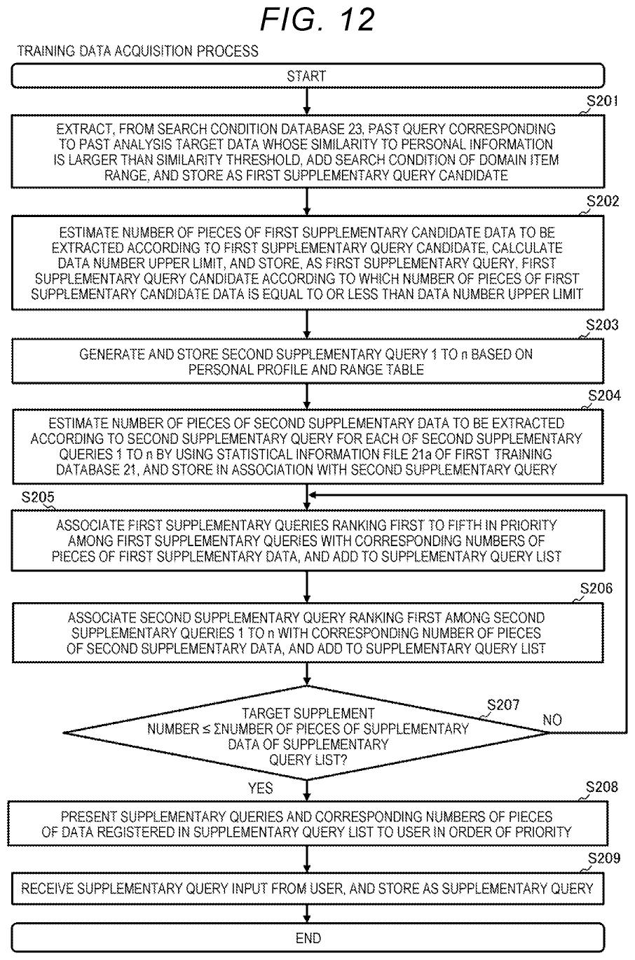

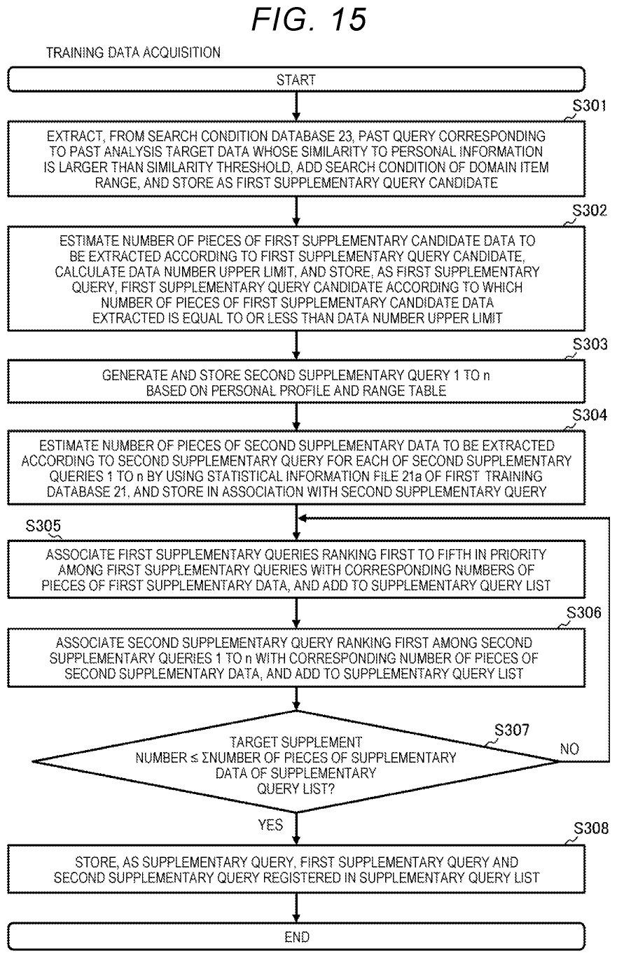

The supplementary query generation unit 12 generates a supplementary query for supplementing training data, which will be described in detail later with reference to flowcharts in FIGS. 12 and 15.

The first training database 21 is a database that stores training data and a statistical information file 21a. The statistical information file 21a includes, for example, information indicating the number of records, information on a maximum value and a minimum value of data for each column, and statistical information such as a histogram indicating a distribution state of the data for each column. Generally, a database has a statistical information file similar to the statistical information file 21a. The AI training data creation support system 1 can access a training database other than the first training database 21 (for example, an external training database of the external training database server 3) and extract training data therefrom.

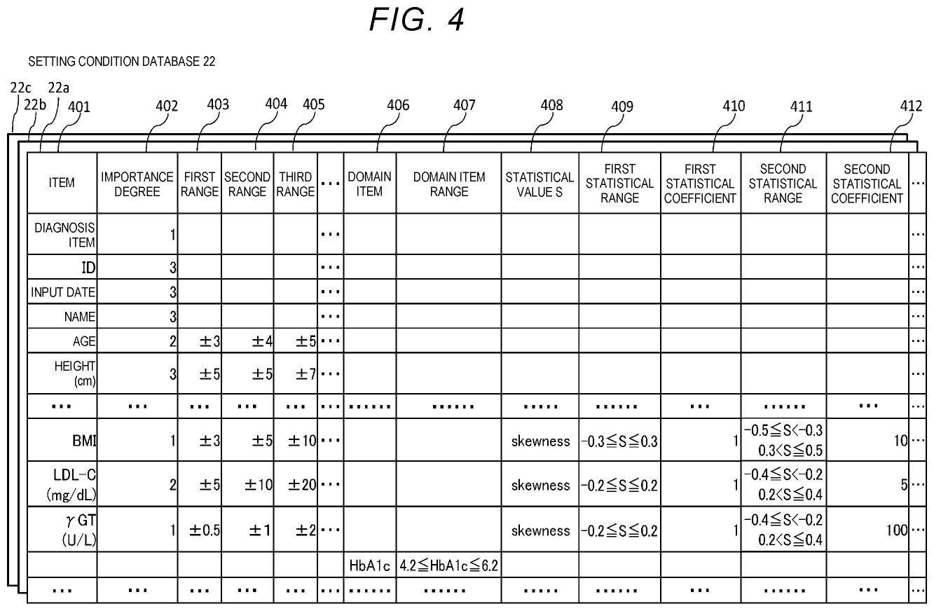

The setting condition database 22 is a database including a range table, a statistical coefficient table, and domain item information, which will be described in detail later with reference to FIG. 4. The range table stores at least one data item of analysis target data of a training profile in association with a plurality of item value ranges respectively corresponding to each of the at least one data item. The statistical coefficient table stores one or more data items of first training data in association with statistical value ranges and statistical coefficients respectively corresponding to each of the one or more data items. The domain item information stores a domain item related to a personal profile (training profile) in association with a domain item range corresponding to the domain item.

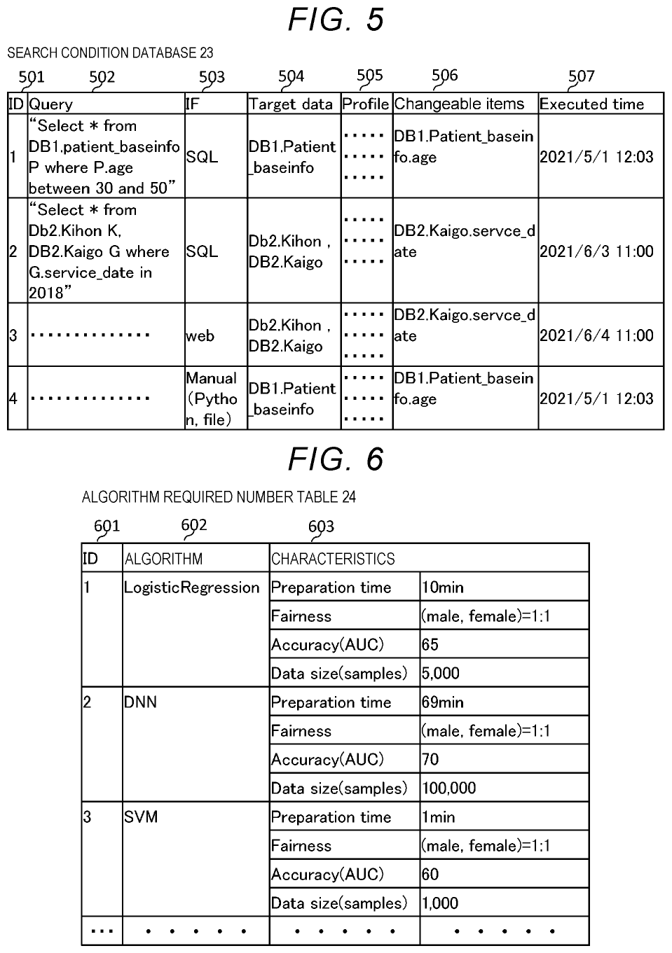

The search condition database 23, which will be described in detail later with reference to FIG. 5, is a database that stores a plurality of search condition records in which past analysis target data (personal information) created in the past and a past query used to extract training data related to the past analysis target data are associated with each other.

The algorithm required number table 24, which will be described in detail later with reference to FIG. 6, stores an algorithm of an AI model in association with an algorithm required number indicating the number of pieces of training data required to train the AI model of the algorithm.

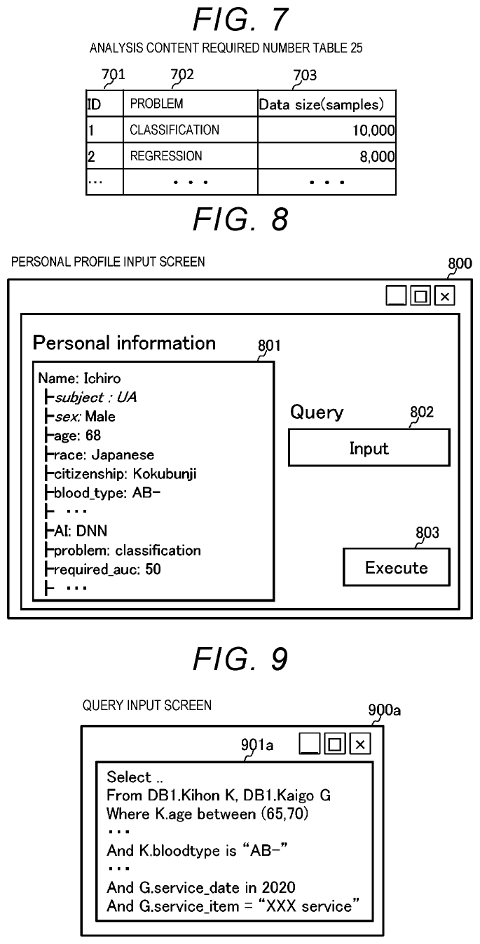

The analysis content required number table 25, which will be described in detail later with reference to FIG. 7, stores analysis content of an AI model in association with an analysis content required number indicating the number of pieces of training data required to train the AI model of the analysis content.

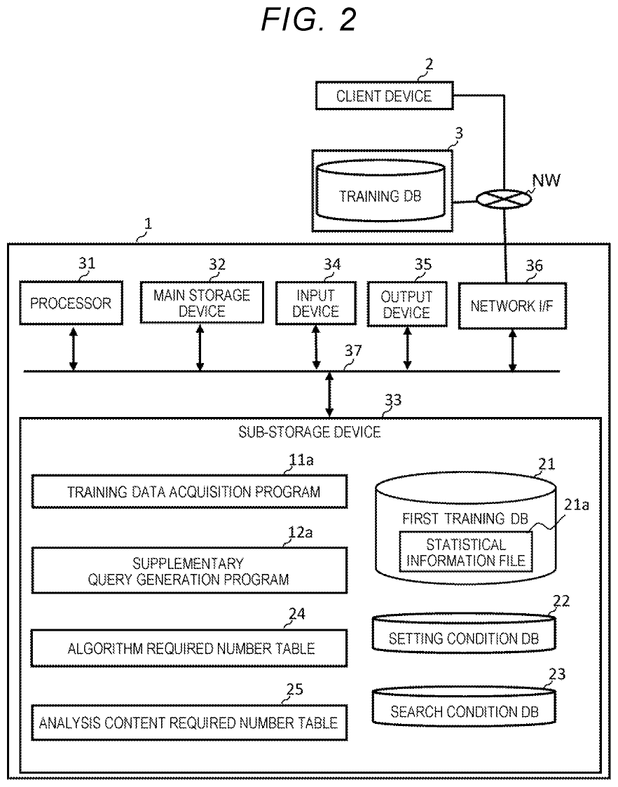

FIG. 2 illustrates an example of a hardware configuration diagram of the AI training data creation support system 1 according to the first embodiment. As illustrated in FIG. 2, the AI training data creation support system 1 includes a processor 31, a main storage device 32, a sub-storage device 33, an input device 34, an output device 35, a network I/F 36, and a bus 37 that connects these components. The AI training data creation support system 1 can be implemented by a general information processing apparatus such as a PC or a server computer.

The processor 31 reads data and a program stored in the sub-storage device 33 into the main storage device 32, and executes processing determined by the program.

The main storage device 32 includes a volatile element such as a RAM, and stores a program to be executed by the processor 31 and data.

The sub-storage device 33 includes a non-volatile storage element such as a hard disk drive (HDD) or a solid-state drive (SSD), and is a device that stores programs, data, and the like. The sub-storage device 33 stores the first training database 21, the setting condition database 22, the search condition database 23, the algorithm required number table 24, and the analysis content required number table 25 described above.

In addition, a training data acquisition program 11a and a supplementary query generation program 12a are installed in the sub-storage device 33. The processor 31 reads the training data acquisition program 11a and the supplementary query generation program 12a stored in the sub-storage device 33 into the main storage device 32 and executes the training data acquisition program 11a and the supplementary query generation program 12a, thereby implementing the training data acquisition unit 11 and the supplementary query generation unit 12 described above with reference to FIG. 1.

The input device 34 is a device for receiving a user's operation, such as a keyboard or a mouse, and acquires information input by the user's operation. The output device 35 is a device for outputting information, such as a display, and presents information to the user by displaying the information on a screen, for example.

The network I/F 36 is an interface for transmitting and receiving data to and from devices such as the client device 2 and the external training database server 3 via the network NW. The AI training data creation support system 1 can use the network I/F 36 to transmit and receive data to and from devices connected to the network NW such as the client device 2 and the external training database server 3. The network I/F 36 can receive information input by the user of the client device 2, whereby the network I/F 36 also functions as an input device. In addition, the network I/F 36 can transmit data to the client device 2 via the network NW and display the data on the display of the client device 2, whereby the network I/F 36 also functions as an output device.

The client device 2 and the external training database server 3 may be implemented by hardware resources similar to those of the AI training data creation support system 1.

### Various Data Structures

FIG. 3 illustrates an example of a personal profile and a first query. A personal profile (training profile) 302 has item values corresponding to a plurality of data items 301, and includes personal information (analysis target data) to be analyzed by an AI model and information on a type of the AI model. The data item 301 includes a plurality of data items related to the personal information (analysis target data) to be analyzed by the AI model and a plurality of data items related to the information on the type of the AI model (an algorithm and analysis content of the AI model).

The plurality of data items related to the personal information (analysis target data) include a diagnosis item and another item. The diagnosis item is an item corresponding to an analysis result to be analyzed by the AI model, and is a so-called objective variable. A data item other than the diagnosis item is a so-called dependent variable. The training data (the first training data, first supplementary data, and second supplementary data) is created so that the AI model after training can analyze an item value of the diagnosis item by using an item value of a data item other than the diagnosis item.

In the personal profile 302 in FIG. 3, a diagnosis item is “UA” as an example, and the AI model after training analyzes personal information (analysis target data) of the personal profile (training profile) and outputs a value “UA” as an analysis result. The diagnosis item can be freely set, and is, for example, a dosage of a drug or a method of treating a human body.

FIG. 3 illustrates an example of a first-query search range (search condition) 303 included in the first query. The first query is used to extract the first training data from the first training database 21 (training database). When the training of the AI model is supervised learning, training data can be the first training data. In the first training data, the item value corresponding to the diagnosis item is data indicating a correct answer or an incorrect answer. Therefore, the first query and a supplementary query (the first supplementary query and the second supplementary query) are set such that data including the item value corresponding to the diagnosis item can be extracted from the training database.

FIG. 4 illustrates an example of the setting condition database 22 and a setting condition table 22a stored in the setting condition database 22. The setting condition database 22 has a setting condition table corresponding to a plurality of diagnosis items (objective variables), and in the example in FIG. 4, setting condition tables 22b and 22c are exemplified in the setting condition database 22 in addition to the setting condition table 22a, and illustration of other setting condition tables is omitted.

The setting condition table 22a includes a range table (a data item 401, a first range 403 to a third range 405) or the like, a statistical coefficient table (the data item 401, a type of a statistical value 408 to a second statistical coefficient 412) or the like, and domain item information (a domain item 406 and a domain item range 407).

The range table stores at least one data item 401 of personal information (analysis target data) of a personal profile (training profile) in association with a plurality of item value ranges (the first range 403 to the third range 405, etc.) respectively corresponding to each of the at least one data item 401.

The data item 401 is a data item corresponding to the personal profile. An importance degree 402 is an importance degree of an item value of the personal information of the personal profile. In FIG. 4, the importance degree 402 is indicated by three numbers 1 to 3 as an example. The smaller the number is, the higher the importance degree is. The first range 403 to the third range 405 are ranges of values for setting a search range included in a supplementary query when creating the supplementary query (second supplementary query) based on the personal profile. Although illustration is omitted except for the first range 403 to the third range 405, the first range 403 to an n-th range are set in the setting condition table 22a. The first range to the n-th range are set in consideration of the importance degree.

The statistical coefficient table stores one or more data items 401 of the first training data, in association with the type of the statistical value 408, a statistical value range (a first statistical range 409, a second statistical range 411, and the like), and a statistical coefficient (a first statistical coefficient 410, a second statistical coefficient 412, and the like) corresponding to each of the one or more data items 401.

The domain item information stores the domain item 406 related to the personal profile (training profile) in association with the domain item range 407 corresponding to the domain item 406. The domain item 406 is an item considered to have an important meaning (large influence) with respect to the diagnosis item (objective variable) of the personal profile (training profile). The domain item 406 is an item that may or may not be included in the data item of the personal profile. The domain item range 407 is a range of values considered to be valid as values related to the domain item 406.

The statistical value 408 is a type of statistical value (for example, skewness) calculated for the first training data extracted from the training database according to the first query. A statistical value of the first training data is calculated for a data item for which the type of the statistical value is set in the statistical value 408 of the setting condition table 22a. Although details will be described later, the first statistical range 409 is a statistical value range related to a statistical value 408, and the first statistical coefficient 410 is a statistical coefficient corresponding to the first statistical range 409. Similarly, the second statistical range 411 is also a statistical value range related to the statistical value 408, and the second statistical coefficient 412 is a statistical coefficient corresponding to the second statistical range 411. The setting condition table 22a stores a plurality of combinations of such statistical ranges and statistical coefficients.

FIG. 5 illustrates an example of the search condition database. The search condition database 23 stores a plurality of search condition records in which past analysis target data (personal information) created in the past and a past query used for extraction of training data regarding the past analysis target data are associated with each other. An ID 501 is an ID for identifying a search condition record. A past query 502 is a past query of each search condition record. An IF 503 is an interface at the time of using the past query 502. A search target 504 is a search target database name of the search condition record.

A personal profile 505 includes the past analysis target data (personal information) created in the past. A changeable item 506 is a data item that is considered to have a low correlation with an analysis result of the AI model among data items of the past analysis target data of the personal profile 505, and is a data item whose search range is considered to be able to be expanded to any range. A creation date and time 507 is a date and time when the record is created.

FIG. 6 illustrates an example of the algorithm required number table 24. The algorithm required number table 24 stores an algorithm of an AI model in association with an algorithm required number indicating the number of pieces of training data required for the algorithm. An ID 601 is an ID for identifying an algorithm. An algorithm 602 is an algorithm of AI to be trained. A characteristic 603 is a column of characteristic related to the algorithm 602. In a field “Data size(samples)”, an algorithm required number corresponding to the algorithm 602 of the AI model is recorded.

FIG. 6 illustrates, as examples of the algorithm 602, logistic regression, deep neural network (DNN), and support vector machine (SVM). The characteristic 603 includes the algorithm required number (field “Data size(samples)”) corresponding to the algorithm 602 of the AI model. The characteristic 603 includes, as an example, “Preparation time” that is an indication of time required to perform training with training data, “Fairness” that is an example of a desirable statistical value of the training data, an approximate value “AUC” of an area under curve (AUC) that is an example of accuracy of an analysis result of the learned AI model, and the algorithm required number (field “Data size(samples)”) corresponding to the algorithm 602 of the AI model.

FIG. 7 illustrates an example of the analysis content required number table 25. The analysis content required number table 25 stores an analysis content 702 of an AI model in association with an analysis content required number 703 indicating the number of pieces of training data required to train the AI model of the analysis content. In the analysis content required number table 25 in FIG. 7, an ID 701 is an ID for identifying analysis content of an AI model. The analysis content 702 is analysis content of AI to be trained, and may be referred to as a “problem”. The analysis content required number 703 is the number of pieces of training data required to train the AI model of the analysis content 702. In FIG. 7, classification and regression are shown as the analysis content 702 as an example, and an example of the analysis content required number 703 corresponding to the classification and regression is shown.

### Processing Procedure

In the first embodiment, a user inputs a personal profile and a first query to the client device 2. Next, the client device 2 transmits the personal profile and the first query to the AI training data creation support system 1. When the AI training data creation support system 1 acquires the personal profile and the first query transmitted from the client device 2, the AI training data creation support system 1 starts training data acquisition. When the user directly inputs the personal profile and the first query to the AI training data creation support system 1 and the personal profile and the first query are received, the AI training data creation support system 1 may start the training data acquisition.

FIG. 8 is an explanatory diagram illustrating an example of a personal profile input screen displayed on a client device 2 in order for a user to input a personal profile and a first query. A personal profile input screen 800 illustrated in FIG. 8 includes an input box 801 for inputting the personal profile, a query input button 802, and a transmission execution button 803.

The input box 801 is a box for the user to input the personal profile. For example, “UA” is input as a diagnosis item to be analyzed by an AI model after training to a portion “subject”, and “Male” is input as a gender to a portion “sex”. “DNN” is input as an algorithm of an AI model to be trained to a portion “AI”. “Classification” is input as analysis content of the AI model to be trained to a portion “problem”. An area under curve (AUC), which is an example of accuracy of an analysis result of the learned AI mode, and “50” as a target value thereof indicating “50%” are input to a portion “required_auc”.

When the user presses the query input button 802, a query input screen for inputting the first query is displayed on the client device 2. When the user presses the transmission execution button 803, information of the personal profile and the first query input by the user is transmitted from the client device 2 to the AI training data creation support system 1 via the network NW.

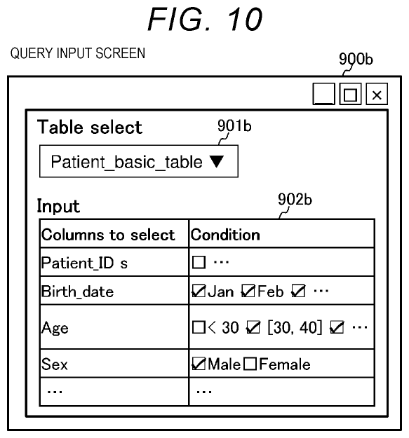

FIGS. 9 and 10 are explanatory diagrams illustrating examples of the query input screen displayed on the client device 2 in order for the user to input a first query. A query input screen 900a illustrated in FIG. 9 includes a box 901a in which the user inputs a first query. A query input screen 900b illustrated in FIG. 10 includes a list selection button 901b for the user to select a data item table for inputting content of the first query, and a data item table 902b. In the example in FIG. 10, the user selects “Patient basic table” with the list selection button 901b, and “Patient basic table” is displayed in the data item table 902b. When the user clicks a check box of the data item table 902b to set a search condition included in the first query, the client device 2 converts the data item table 902b into the first query.

Next, the training data acquisition executed by the training data acquisition unit 11 of the AI training data creation support system 1 will be described with reference to FIG. 11. FIG. 11 is a flowchart illustrating an example of the training data acquisition of the AI training data creation support system 1. As described above, when the AI training data creation support system 1 receives the personal profile and the first query from the client device 2, the AI training data creation support system 1 starts the training data acquisition illustrated in the flowchart in FIG. 11.

The AI training data creation support system 1 (processor 31) stores the personal profile and the first query received from the client device 2 (step S101).

Next, the AI training data creation support system 1 extracts the setting condition table 22a related to a diagnosis item of the personal profile from the setting condition database 22 (see FIG. 4) and stores the setting condition table 22a (step S102).

Next, the AI training data creation support system 1 uses the statistical information file 21a of the first training database 21 to calculate and store the number of pieces and a statistical value of the first training data to be extracted from the first training database 21 according to the first query (step S103). Here, the AI training data creation support system 1 uses the statistical information file 21a of the first training database 21 to estimate the number of pieces of the first training data by a known method as described below. With respect to all data items for which types of statistical values are set in the statistical value 408 (see FIG. 4) of the setting condition table 22a, the AI training data creation support system 1 uses the statistical information file 21a to calculate statistical values of the types set in the statistical value 408 by a known method for the first training data, and sets the calculated statistical values as the statistical values. Here, the AI training data creation support system 1 calculates the number of pieces and the statistical values of the first training data by using the statistical information file 21a. Accordingly, the AI training data creation support system 1 can more easily calculate the number of pieces and the statistical values of the first training data, as compared with a case where the AI training data creation support system 1 extracts the first training data from the first training database 21 and calculates the number of pieces and the statistical values of the first training data.

Generally, a database has a statistical information file. The statistical information file includes, for example, information indicating the number of records, information on a maximum value and a minimum value of data for each column, and statistical information such as a histogram indicating a distribution state of the data for each column. For example, the number Ra of records in which a value of a data item A is recorded can be estimated. In addition, the number Raa of records in which the value of the data item A is in a range A can be estimated based on information of a histogram. Accordingly, it is possible to estimate a ratio Rpa (Rpa=Raa/Ra) of the records, in which the value of the data item A is in the range A, to the records having the value of the data item A. Similarly, the number Rb of records in which a value of a data item B is recorded can be estimated. It is possible to estimate a ratio Rpb of records, in which the value of the data item B is in a range B, to the records having the value of the data item B. Therefore, the number AB of records in which the value of the data item A is in the range A and the value of the data item B is in the range B can be estimated as a product of the number Ra of the records in which the value of the data item A is recorded, the ratio Rpa of the records in which the value of the data item A is in the range A, and the ratio Rpb of the records in which the value of the data item B is in the range B (the number AB of records=the number Ra of records×the ratio Rpa of records×the ratio Rpb of records). In this way, the number of pieces of first training data is calculated by calculating a product of the number of records in which a data item is recorded and a ratio of the records. A statistical value “skewness” or “kurtosis” of a value of the data item of the first training data can be estimated based on a histogram or the like of the data item.

Further, for example, in the example of the setting condition table 22a illustrated in FIG. 4, the statistical value 408 of an item of BMI is “skewness”, and the AI training data creation support system 1 calculates a value “skewness” of the BMI of the first training data by using the statistical information file 21a and sets the value as the statistical value of the BMI. In the example in FIG. 4, for the items of LDL-C, γGT, and the like, statistical values “skewness” or the like are similarly calculated and used as the statistical values of the items respectively. The “skewness” is an example of a statistical value indicating variation of the first training data, and another statistical value may be used instead of the “skewness”. For example, “kurtosis” may be used as the statistical value, or both “skewness” and “kurtosis” may be used.

Next, the AI training data creation support system 1 stores the personal profile and the first query in association with each other in a search condition database (see FIG. 5) (step S104). Here, a data item having the lowest importance degree of 3 in the setting condition table 22a may be set as a changeable item (a data item whose search range is considered to be able to be expanded to any range, see FIG. 5) of a search condition record (see FIG. 5).

Next, the AI training data creation support system 1 calculates a required-number upper limit, calculates the number of pieces of data required to train the AI model, as a required number, based on the required-number upper limit, an algorithm of an AI model (a type of the AI model), the setting condition table 22a, and the statistical value of the first training data, and stores the required number (step S105). Here, the required-number upper limit is an approximate value of the number of pieces of the first training data that can be acquired by the AI training data creation support system 1 at a first allowable time interval (for example, 6 hours) considered to be sufficiently short in a case where the AI training data creation support system 1 acquires the first training data from the first training database 21. The first allowable time interval is set in advance. When the number of pieces of the first training data is equal to or less than the required-number upper limit (the number of pieces of the first training data the required-number upper limit), it can be determined that time required to acquire the first training data is sufficiently short. On the other hand, when the number of pieces of the first training data is greater than the required-number upper limit (the number of pieces of the first training data>the required-number upper limit), it can be determined that the time required to acquire the first training data is too long.

The required-number upper limit is, for example, a product of the first allowable time interval and a first training data acquisition speed. The first training data acquisition speed represents the number of pieces of the first training data that can be acquired from the first training database 21 per unit time. The AI training data creation support system 1 calculates the first training data acquisition speed based on, for example, specifications of the processor 31 such as the number of cores and the number of clocks of the processor 31, an estimated use rate (operation status) of the processor 31 that can be allocated to acquire first supplementary data, and a reading speed and a writing speed of the main storage device 32. The AI training data creation support system 1 may measure the first training data acquisition speed by executing a predetermined program. The AI training data creation support system 1 calculates a product of the first allowable time interval and the first training data acquisition speed, and sets the product as the required-number upper limit.

In calculating the required number, the required-number upper limit, the algorithm required number table 24, the analysis content required number table 25, the statistical value calculated in step S103, and the setting condition table 22a are used as follows. As described above, information on an algorithm and analysis content of the AI model to be trained is included in the personal profile. For example, in the personal profile illustrated in FIG. 3, the algorithm is “deep neural network (DNN)”, and the analysis content is “classification”.

In the calculation of the required number, first, an algorithm required number corresponding to the algorithm of the AI model is extracted from the algorithm required number table 24, an example of which is illustrated in FIG. 6, and an analysis content required number corresponding to the analysis content of the AI model is extracted from the analysis content required number table 25, an example of which is illustrated in FIG. 7. A larger one of the algorithm required number and the analysis content required number is set as a model required number M.

For example, in the algorithm required number table 24 illustrated in FIG. 6, the algorithm required number corresponding to the algorithm “DNN” of the AI model is 100,000. In the example of the analysis content required number table 25 illustrated in FIG. 7, the algorithm required number corresponding to the analysis content “classification” of the AI model is 10,000. The larger one of 100,000 indicating the number of pieces of data is the model required number M (the model required number M=100,000). Although the algorithm required number table 24 and the analysis content required number table 25 are used in the above description, change can be appropriately made as follows. For example, a database in which a set of the algorithm and the analysis content and the model required number M are stored in association with each other may be generated in advance and used, the set of the algorithm and the analysis content being obtained by integrating the algorithm required number table 24 and the analysis content required number table 25 into one. The model required number M may be calculated using only the algorithm required number table 24. Alternatively, the model required number M may be calculated using only the analysis content required number table 25. Further, the model required number M may be calculated in consideration of matters other than the algorithm and the analysis content of the AI model.

In addition, for each data item for which the statistical value is calculated, a statistical coefficient is calculated as follows, and a largest statistical coefficient among the calculated statistical coefficients is defined as a maximum statistical coefficient C. A product of the model required number M and the maximum statistical coefficient C is defined as a required number D (the required number D=the model required number M×the maximum statistical coefficient C). Further, when the required number D is greater than the required-number upper limit (the required number D>the required-number upper limit), the required number D is set to the required-number upper limit. The statistical coefficient is a statistical coefficient (any one of a first statistical coefficient to an n-th statistical coefficient) corresponding to a range including a statistical value in a first statistical range to an n-th statistical range.

In the example of the setting condition table 22a in FIG. 4, when a statistical value of the BMI is 0.4, the statistical value (0.4) falls within the second statistical range 411, and 10 that is the second statistical coefficient 412 corresponding to the second statistical range 411 is set as the statistical coefficient of the data item BMI (statistical coefficient=10). Similarly, when a statistical value of the data item LDL-C is 0.1, the statistical value falls within the first statistical range 409, and a value 1 of the first statistical coefficient 410 is the statistical coefficient of the data item LDL-C (statistical coefficient=1). When a maximum value of the values of the statistical coefficients of all the data items is 10, the maximum statistical coefficient C is 10. As described above, when the model required number M is 100,000, the required number D is 1,000,000 (=the model required number M 100,000×the maximum statistical coefficient 10).

Further, when the required number D (the required number D=the product of the model required number M and the maximum statistical coefficient C) is greater than the required-number upper limit (the required number D>the required-number upper limit), it is considered that the time required to acquire the required number D of pieces of the first training data is too long, and thus the required number D is set to the required-number upper limit (the required number D=the required-number upper limit). Accordingly, the AI training data creation support system 1 can more reliably generate (extract) the first training data, and the first supplementary data and the second supplementary data to be described later. In step S105, the AI training data creation support system 1 may not calculate the required-number upper limit, and may not set the required number D to the required-number upper limit when the required number D is greater than the required-number upper limit (required number D>required-number upper limit).

The required number D may be calculated in consideration of a training method of the AI model. For example, similar to the statistical coefficient described above, a statistical coefficient related to the training method may be created to calculate the required number D. Examples of the training method include leave-one-out in which cross validation is performed by extracting only one piece of training data as test data from all pieces of training data and using the remaining training data as training data, hold-out, and cross validation.

Next, returning to FIG. 11, the AI training data creation support system 1 determines whether the number of pieces of the first training data calculated in step S103 is equal to or greater than the required number calculated in step S105 (the required number the number of pieces of the first training data) (step S106). When it is determined that the number of pieces of the first training data is equal to or greater than the required number (the required number the number of pieces of the first training data) (step S106: YES), the processing proceeds to step S107, and when it is determined that the number of pieces of the first training data is less than the required number (the required number>the number of pieces of the first training data) (step S106: NO), the processing proceeds to step S108.

Next, the AI training data creation support system 1 extracts the first training data from the first training database by using the first query, outputs the extracted first training data, and ends the processing (step S107). Here, the output of the first training data may be the following output. For example, the first training data is transmitted to the client device 2. A file including the first training data is transmitted to the client device 2. A file including the first training data is stored in the sub-storage device 33. The first training data is output to the output device 35 to be presented to the user of the AI training data creation support system 1. The first training data is transmitted to the client device 2, and the client device 2 presents the first training data to the user. Here, the presentation performed by the client device 2 to the user may be output to the display of the client device 2. For example, the output may be standard output displayed on the display of the client device 2. The standard output is a data output destination that is used by a device (such as an operating system of the device) in a standard manner when a program executed on a computer is not particularly specified.

Next, the AI training data creation support system 1 calculates a difference between the required number and the number of pieces of the first training data, and stores the difference as a target supplement number (the target supplement number=the required number−the number of pieces of the first training data) (step S108).

Next, the AI training data creation support system 1 calls a supplementary query generation subroutine (step S109). The supplementary query generation subroutine is processing executed by the supplementary query generation unit 12 of the AI training data creation support system 1, in which a supplementary query is generated in order to supplement the training data.

Next, the AI training data creation support system 1 extracts the first training data from the first training database by using the first query, extracts supplementary data from the database by using the supplementary query, outputs the first training data and the supplementary data, and ends the processing (step S110). Here, the output of the first training data and the supplementary data may be the following output similarly to that in step S107 described above. For example, the first training data and the supplementary data are transmitted to the client device 2. A file including the first training data and the supplementary data is transmitted to the client device 2. A file including the first training data and the supplementary data is stored in the sub-storage device 33. The first training data and the supplementary data are transmitted to the client device 2, and the client device 2 presents the first training data and the supplementary data to the user. Here, the presentation performed by the client device 2 to the user may be output to the display of the client device 2. For example, the output may be standard output displayed on the display of the client device 2.

Next, the processing of the supplementary query generation subroutine executed by the supplementary query generation unit 12 of the AI training data creation support system 1 will be described with reference to FIGS. 12, 13 and 14. FIG. 12 is a flowchart illustrating an example of the processing of the supplementary query generation subroutine.

The AI training data creation support system 1 extracts, from the search condition database, at least one search condition record including past analysis target data whose similarity to personal information (analysis target data) of a personal profile (training profile) is larger than a predetermined similarity threshold, and stores a past query of the at least one extracted search condition record as a first supplementary query candidate (step S201). Here, as described above with reference to FIG. 3, the personal information of the personal profile includes item values of various data items.

The similarity is, for example, a ratio of the number of data items of the personal information of the personal profile (the number of data items of name and ID is excluded) to the number of data items (the number of data items of name and ID is excluded) included in both the personal information of the personal profile and the past analysis target data (personal information) of the search condition record. That is, “similarity=the number of data items included in both sides/the number of data items of the personal information”. In addition, as the number of data items included in both the personal information of the personal profile and the past analysis target data (personal information) of the search condition record increases, the similarity increases. The name and the ID are information having a low correlation with personal qualities, and the other data items are considered to have a high correlation with the personal qualities. In the calculation of the similarity, the number of data items of the name and the ID is excluded from the number of data items, so that the similarity is a similarity related to the personal qualities. Accordingly, the similarity is a suitable similarity.

For example, it is assumed that the data items of the personal information of the personal profile are “ID, diagnosis item, name, age, height, BMI, LDL-C”, and the data items of the past analysis target data of the search condition record are “diagnosis item, name, age, height”. The number of data items related to the personal qualities included in the personal profile is 5, which is the number of data items excluding the data items “ID” and “name”. The number of data items included in both the personal information of the personal profile and the past analysis target data (personal information) of the search condition record is 3 including the data items “diagnosis item, age, height”. The similarity (=the number of data items included in both sides/the number of data items of personal information) is ⅗=0.6.

The similarity threshold is a threshold related to the similarity set in advance, and is, for example, 0.5.

In step S201, a domain item range (see FIG. 4) is added as a search condition to the past query of the search condition record including the past analysis target data whose similarity to the personal information of the personal profile is larger than the similarity threshold, and the result is set as the first supplementary query candidate. For example, in the example of the domain item range illustrated in FIG. 4, the domain item range 407 is “4.2 HbA1c≤6.2”. In the example in FIG. 4, the AI training data creation support system 1 first extracts, from the setting condition database 22, past analysis target data whose similarity to the personal information of the personal profile is larger than the similarity threshold. A query obtained by adding the domain item range “4.2≤HbA1c≤6.2” as a search condition to the past query of the search condition record including the extracted past analysis target data is set as the first supplementary query candidate.

As described above with reference to FIG. 4, a domain item relates to a personal profile (training profile). The domain item is an item considered to have an important meaning (large influence) with respect to a diagnosis item (objective variable) of the personal profile (training profile). A domain item range is a range of values considered to be valid as values related to the domain item. The first supplementary data, which is training data, is generated (extracted) based on the first supplementary query selected from first supplementary query candidates. Therefore, the AI training data creation support system 1 adds the domain item range as a search condition to the first supplementary query candidate. Accordingly, the AI training data creation support system 1 generates the first supplementary query including the domain item range as a search condition. Accordingly, the first supplementary data (training data) can be made suitable data having a higher correlation with the diagnosis item (objective variable).

A query whose search range of the changeable item 506 (see FIG. 5) of the search condition record is expanded appropriately (for example, by 10%) from a past query may be generated, and a query obtained by adding a search condition according to the domain item range to the generated query may be set as the first supplementary query candidate. In addition, the personal profile of the search condition record of the search condition database 23 may be extracted by using the first query, and the search condition according to the domain item range may be added to a past query related to the extracted personal profile, and the obtained query may be set as the first supplementary query candidate.

Next, the AI training data creation support system 1 uses a statistical information file of a training database to estimate the number of pieces of first supplementary candidate data to be extracted from the training database according to the first supplementary query candidate, calculates a data number upper limit, sets, as the first supplementary query, the first supplementary query candidate according to which the number of pieces of the first supplementary candidate data extracted is equal to or less than the data number upper limit, and stores the first supplementary query in association with the number of the first supplementary queries (step S202). Here, as illustrated in the search target 504 in FIG. 5, depending on the first supplementary query candidate, a corresponding training database is a training database other than the first training database 21 included in the AI training data creation support system 1. When the training database corresponding to the first supplementary query candidate is the first training database 21, the number of first supplementary query candidates is the number of pieces of data obtained by excluding overlapping data between the first supplementary candidate data and first data from the first supplementary candidate data. The number of pieces of the overlapping data is the number of pieces of data extracted from the first training database 21 according to a query obtained by adding the search condition of the first supplementary query candidate to the search condition of the first query. The number of pieces of the first supplementary candidate data is a number obtained by subtracting the number of pieces of the overlapping data from the number of pieces of data extracted according to the first supplementary query candidate. The AI training data creation support system 1 calculates the number of pieces of the data extracted according to the first supplementary query candidate and the number of pieces of the overlapping data by using the first training database 21, and further calculates the number of pieces of the first supplementary candidate data by obtaining a difference between the number of pieces of the data extracted according to the first supplementary query candidate and the number of pieces of the overlapping data.

Generally, a training database has a statistical information file. In step S202, with the same method as in step S103 of the training data acquisition in FIG. 11, the AI training data creation support system 1 estimates the number of pieces of the first supplementary data to be extracted according to the first supplementary query candidate, by using a statistical information file included in a training database designated in the first supplementary query candidate.

The data number upper limit is an approximate value of the number of pieces of the first supplementary candidate data that can be acquired by the AI training data creation support system 1 at a second allowable time interval (for example, 6 hours) considered to be sufficiently short in a case where the AI training data creation support system 1 acquires the first supplementary candidate data from the training database. The second allowable time interval is set in advance. The AI training data creation support system 1 calculates, for example, a product of the second (predetermined) allowable time interval and a first supplementary data acquisition speed as an acquisition data upper limit number. The first supplementary data acquisition speed represents the number of pieces of the first supplementary candidate data that can be acquired from the training database per unit time. The AI training data creation support system 1 calculates the first supplementary data acquisition speed based on, for example, the specifications of the processor 31 such as the number of cores and the number of clocks of the processor 31, the estimated usage rate (operation status) of the processor 31 that can be allocated to acquire the first supplementary candidate data, a reading speed and a writing speed of the main storage device 32, and a transmission speed and a reception speed of the network. The AI training data creation support system 1 may measure the first supplementary data acquisition speed by executing a predetermined program.

When the number of pieces of the first supplementary candidate data is equal to or less than the data number upper limit (the number of pieces of the first supplementary candidate data the data number upper limit), it can be determined that time required to acquire the first supplementary candidate data is sufficiently short. On the other hand, when the number of pieces of the first supplementary candidate data is greater than the data number upper limit (the number of pieces of the first supplementary candidate data>the data number upper limit), it can be determined that the time required to acquire the first supplementary candidate data is too long.

The AI training data creation support system 1 sets the first supplementary query candidate, according to which the number of pieces of the first supplementary candidate data extracted is equal to or less than the data number upper limit (the number of pieces of the first supplementary candidate data the data number upper limit), as the first supplementary query. The AI training data creation support system 1 stores the first supplementary query in association with the number of the first supplementary queries (the number of pieces of the first supplementary candidate data). Accordingly, the AI training data creation support system 1 can more reliably generate (extract) the first supplementary data by using the first supplementary query. In step S202, the AI training data creation support system 1 may not calculate the data number upper limit, and may set all the first supplementary query candidates as the first supplementary query regardless of the data number upper limit.

It is assumed that m (a plurality of) first supplementary queries are extracted. In addition, the first supplementary queries 1 to m are extracted in this order.

Next, the AI training data creation support system 1 generates and stores second supplementary query 1 to second supplementary query n based on the personal profile and the range table (setting condition table 22a) (step S203).

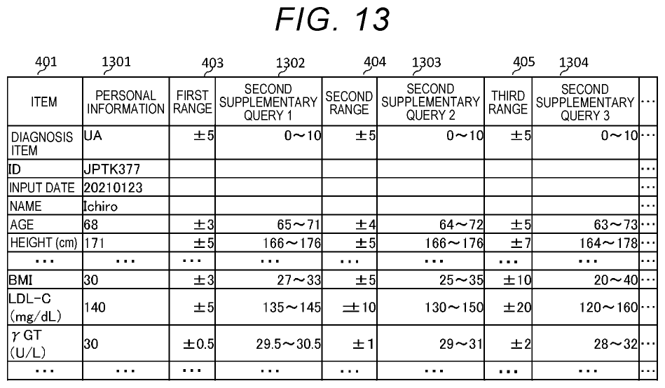

FIG. 13 is a table illustrating a method of generating a second supplementary query. FIG. 13 includes the data item 401, personal information 1301, the first range 403, a column 1302 of a second supplementary query 1, the second range 404, a column 1303 of a second supplementary query 2, the third range 405, and a column 1304 of a second supplementary query 3. Here, the data item 401, the first range 403, the second range 404, and the third range 405 are the same as those in the range table of the setting condition table 22a illustrated in FIG. 4. The second supplementary query 1 shown in the column 1302 of the second supplementary query 1 is a query including a search range obtained by expanding an item value of the personal information 1301 according to the first range 403. For example, in a row in which the data item 401 is “diagnosis item”, the personal information 1301 is UA, and the first range is ±5. Since a minimum value of UA is 0 due to the nature of UA, a search range of the “diagnosis item” of the second supplementary query 1 is 0 to 10. Similarly, in a row in which the data item 401 is “age”, since the personal information 1301 is 68 and the first range is ±3, a search range of the second supplementary query 1 is 65 to 71. Similarly to the second supplementary query 1 described above, the second supplementary query 2 indicated in the column 1303 of the second supplementary query 2 and the second supplementary query 3 indicated in the column 1304 of the second supplementary query 3 are generated, and further, a second supplementary query 4 to the second supplementary query n corresponding to a fourth range to an n-th range (not illustrated) are generated.

Next, the AI training data creation support system 1 estimates the number of pieces of second supplementary data to be extracted according to a second supplementary query for each of the second supplementary queries 1 to n, and stores the estimated numbers of pieces of the second supplementary data in association with the second supplementary queries 1 to n (step S204).

Here, with the same method as in step S202 described above, the AI training data creation support system 1 uses the statistical information file 21a of the first training database 21 to estimate the number of pieces of the second supplementary data 1 to n to be extracted from the first training database 21 according to the second supplementary queries 1 to n. That is, the number of pieces of the second supplementary data 1 to n is the number of pieces of data obtained by excluding overlapping data between the second supplementary data 1 to n and the first data from the second supplementary data 1 to n. The number of pieces of the overlapping data is the number of pieces of data extracted from the first training database 21 according to queries obtained by adding search conditions of the second supplementary queries 1 to n to the search condition of the first query. The number of pieces of the second supplementary data 1 to n is a number obtained by subtracting the number of pieces of the overlapping data from the number of pieces of data extracted according to the second supplementary queries 1 to n. The AI training data creation support system 1 calculates the number of pieces of the data extracted according to the second supplementary queries 1 to n and the number of pieces of the overlapping data by using the first training database 21, and further calculates the number of pieces of the second supplementary data 1 to n by obtaining a difference between the number of pieces of the data extracted according to the second supplementary queries 1 to n and the number of pieces of the overlapping data.

The training database, from which the second supplementary data 1 to n is extracted according to the second supplementary queries 1 to n, may be a training database other than the first training database 21 (for example, an external training database of the external training database server 3). In addition, a second supplementary query, according to which the number of pieces of the second supplementary data is greater than the required-number upper limit (the number of pieces of the second supplementary data>the required-number upper limit), may be excluded from the second supplementary queries 1 to n. Accordingly, the AI training data creation support system 1 can more reliably generate (extract) the first supplementary data.

Next, the AI training data creation support system 1 associates queries ranking the first to the fifth in priority (that is, a predetermined number of queries) among the first supplementary queries 1 to m with the corresponding numbers of pieces of the first supplementary data, and adds the queries ranking the first to the fifth in priority to a supplementary query list (not illustrated) (step S205). Here, the priority is defined by, for example, the number of pieces of the first supplementary data. That is, a first supplementary query, according to which the number of pieces of the first supplementary data is larger, is given a higher priority and is added to the supplementary query list. The supplementary query list is a list in which a query, among the first supplementary queries 1 to m and the second supplementary queries 1 to n, adopted as a supplementary query for supplementing the first query is registered in association with the corresponding number of pieces of supplementary data.

Next, the AI training data creation support system 1 associates a second supplementary query ranking the first among the second supplementary queries 1 to n with the corresponding number of pieces of the second supplementary data, and adds the second supplementary query ranking the first to the supplementary query list (step S206). Here, a query closer to the second supplementary query 1 ranks higher (second supplementary query 1>second supplementary query 2> . . . >second supplementary query n).

In addition, a second supplementary query and the corresponding number of pieces of supplementary data, which are registered in the supplementary query list, are replaced with the second supplementary query ranking the first and the corresponding number of pieces of the supplementary data that are not yet registered in the supplementary query list. This means the following: the second supplementary query registered in the supplementary query list is changed such that the search range corresponding to at least one data item is expanded, the number of pieces of the second supplementary data corresponding to the changed second supplementary query is calculated, and the number of pieces of the second supplementary data registered in the supplementary query list is replaced with the calculated number of pieces of the second supplementary data.

Next, the AI training data creation support system 1 determines whether a sum of the number of pieces of the first supplementary data and the number of pieces of the second supplementary data registered in the supplementary query list is equal to or greater than the target supplement number (Σthe number of pieces of the supplementary data of the supplementary query list the target supplement number) (step S207). When it is determined that the sum of the number of pieces of the first supplementary data and the number of pieces of the second supplementary data registered in the supplementary query list is equal to or greater than the target supplement number (Σthe number of pieces of the supplementary data of the supplementary query list the target supplement number) (step S207: YES), the processing proceeds to step S208, and when it is determined that the sum of the number of pieces of the first supplementary data and the number of pieces of the second supplementary data registered in the supplementary query list is less than the target supplement number (Σthe number of pieces of the supplementary data of the supplementary query list<the target supplement number) (step S207: NO), the processing returns to step S205.

Here, when it is determined that the sum of the number of pieces of the first supplementary data and the number of pieces of the second supplementary data registered in the supplementary query list is equal to or greater than the target supplement number (the target supplement number=the required number−the number of pieces of the first training data) (target supplement number=the required number−the number of pieces of the first training data≤Σthe number of pieces of the supplementary data of the supplementary query list) (step S207: YES), the following can be considered. That is, a total number of pieces of data, which is obtained by adding the number of pieces of the first training data extracted according to the first query to the total number of pieces of the supplementary data extracted according to the queries registered in the supplementary query list, is equal to or greater than the required number of pieces of data required to train the AI model (the required number≤the number of pieces of the first training data+Σthe number of pieces of the supplementary data of the supplementary query list). Accordingly, training data of a sufficient number can be collected according to the queries registered in the supplementary query list and the first query.

Next, the AI training data creation support system 1 presents the supplementary queries (the first supplementary query and the second supplementary query) and the corresponding numbers of pieces of the supplementary data registered in the supplementary query list to the user in order of priority (step S208). That is, the supplementary queries are presented to the user by using the output device so that the user can select a supplementary query to be used from the first supplementary query and the second supplementary query. Here, with respect to the presentation to the user, when the AI training data creation support system 1 transmits the supplementary query list to the client device 2, the client device 2 displays the supplementary queries and the corresponding numbers of pieces of the supplementary data on the display of the client device 2 in order of priority based on the supplementary query list. Further, the user of the client device 2 selects a supplementary query to be used for supplementing the first query from the displayed supplementary queries.

Instead of displaying the supplementary queries on the display of the client device 2, the supplementary queries may be output to the output device 35 of the AI training data creation support system 1 to be presented to the user of the AI training data creation support system 1, and the user may select the supplementary query.

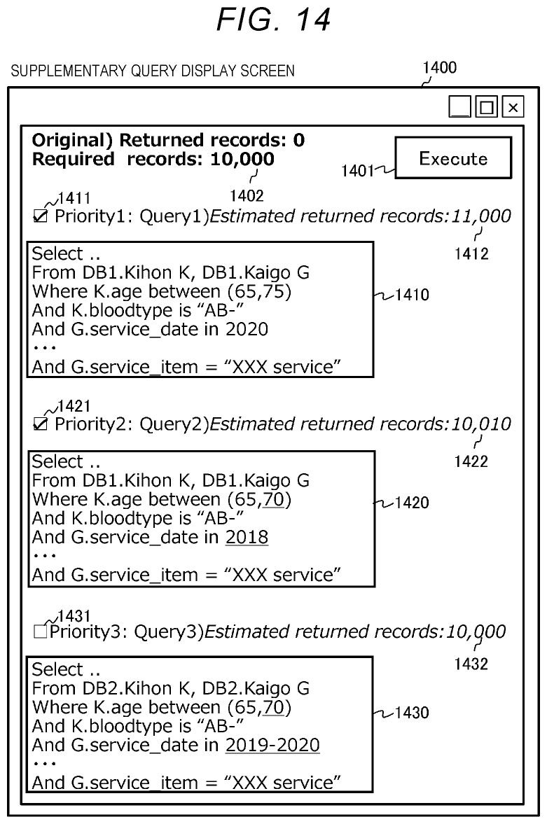

FIG. 14 is an explanatory diagram illustrating an example of a supplementary query display screen displayed on the display of the client device 2 in order to present, to the user, supplementary queries and the corresponding numbers of pieces of supplementary data registered in the supplementary query list.

In a supplementary query display screen 1400 illustrated in FIG. 14, the supplementary queries are displayed in descending order of priority from the top. Here, the priority is defined by, for example, the number of pieces of supplementary data. The supplementary query display screen 1400 includes a transmit button 1401 and a target supplement number 1402. The supplementary query display screen 1400 includes, for a supplementary query 1410 with a priority of 1, a check box 1411, and the number 1412 of pieces of supplementary data extracted according to the supplementary query 1410. The supplementary query display screen 1400 includes, for a supplementary query 1420 with a priority of 2, a check box 1421 and the number 1422 of pieces of supplementary data extracted according to the supplementary query 1420. In addition, the supplementary query display screen 1400 includes, for a supplementary query 1430 with a priority of 3, a check box 1431 and the number 1432 of supplementary data extracted according to the supplementary query 1430.

The user of the client device 2 can select a supplementary query to be used for supplementing the first query by clicking on the check box 1411, the check box 1421, and the check box 1431. When the user finishes selecting the supplementary query, the user presses the transmit button 1401. Accordingly, the client device 2 transmits the supplementary query selected by the user to the AI training data creation support system 1.

As shown in the supplementary query display screen 1400 in FIG. 14, the supplementary queries 1410 and 1420 with the priorities of 1 and 2 corresponding to the checked check boxes 1411 and 1421 are selected as the supplementary queries, and the supplementary query 1430 with the priority of 3 corresponding to the unchecked check box 1431 is not selected.

Next, returning to FIG. 12, the AI training data creation support system 1 receives an input of the supplementary query to be used selected by the user, stores the input supplementary query as a supplementary query, and ends the processing (step S209). When the processing ends, the AI training data creation support system 1 performs the processing of step S110 of the training data acquisition in FIG. 11. In step S110, the AI training data creation support system 1 extracts the first training data from the training database according to the first query, and extracts the supplementary data (the first supplementary data and the second supplementary data) from the training database according to the supplementary query selected by the user and input in step S209. Then, the AI training data creation support system 1 outputs the first training data and the supplementary data by using the output device 35 or the network I/F 36.

As described above, in the first embodiment, the AI training data creation support system 1 generates a supplementary query that can be used to acquire supplementary data for supplementing first training data. Accordingly, training data for training an AI model can be efficiently collected.

The AI training data creation support system 1 can easily collect the training data for training the AI model, by outputting the first training data and the supplementary data.

The AI training data creation support system 1 calculates the required number based on an algorithm and analysis content of the AI model to be trained. Therefore, the required number is set more appropriately, and further, training data can be collected at a more appropriate number.

The AI training data creation support system 1 calculates the required number based on statistical values of one or more data items of the first training data. Therefore, the required number is set more appropriately, and further, training data can be collected at a more appropriate number.

The AI training data creation support system 1 generates a first supplementary query from a past query created in the past of the search condition database 23. Accordingly, the training data for training the AI model can be efficiently collected.

The AI training data creation support system 1 generates a second supplementary query by using personal information (analysis target data) of a personal profile (training profile). Accordingly, the training data for training the AI model can be efficiently collected.

In addition, input of the first supplementary query and the second supplementary query selected by the user is received, and supplementary data is created by using the first supplementary query or the second supplementary query selected by the user. Accordingly, the training data collected by using the supplementary query can be more appropriate training data.

### Second Embodiment

In the first embodiment, in the processing of the supplementary query generation subroutine shown in the flowchart in FIG. 12, a supplementary query is selected by the user from the first supplementary query and the second supplementary query registered in the supplementary query list (steps S208 and S209 in FIG. 12). A second embodiment is different from the first embodiment in that the AI training data creation support system 1 generates a supplementary query without the user selecting a supplementary query. In the AI training data creation support system 1 according to the second embodiment, parts and configurations having the same functions as those of the AI training data creation support system 1 according to the first embodiment are denoted by the same reference signs, and a description thereof will be omitted.

FIG. 15 is a flowchart illustrating an example of processing of a supplementary query generation subroutine according to the second embodiment. Processing of steps S301 to S307 in the flowchart illustrated in FIG. 15 is the same as the processing of steps S201 to S207 in the flowchart of the processing of the supplementary query generation subroutine of the first embodiment illustrated in FIG. 12, and thus a description thereof will be omitted.

In step S308, the AI training data creation support system 1 stores, as a supplementary query, the supplementary query registered in the supplementary query list, and ends the processing.

As described above, in the second embodiment, since the supplementary query is automatically generated without the user selecting the supplementary query, it is possible to efficiently collect training data.

### Third Embodiment

In the first embodiment, the first query generated by the user of the client device 2 is used for the training data acquisition. Differently from the first embodiment, in a third embodiment, the first query is generated by the AI training data creation support system 1. In the AI training data creation support system 1 according to the third embodiment, parts and configurations having the same functions as those of the AI training data creation support system 1 according to the first embodiment are denoted by the same reference signs, and a description thereof will be omitted.

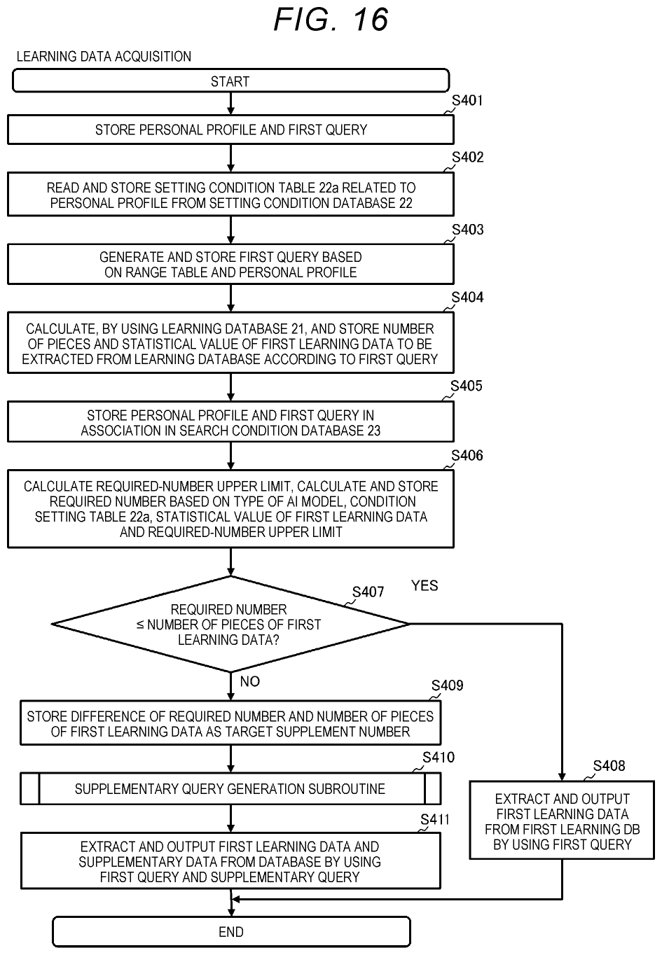

When the AI training data creation support system 1 according to the third embodiment receives a personal profile from the client device 2, the AI training data creation support system 1 starts training data acquisition illustrated in the flowchart in FIG. 16.

FIG. 16 is a flowchart illustrating an example of the training data acquisition according to the third embodiment.

The AI training data creation support system 1 stores the personal profile received from the client device 2 (step S401).

Next, the AI training data creation support system 1 reads the setting condition table 22a related to the personal profile from the setting condition database 22, and stores the setting condition table 22a (step S402). The processing of step S402 is the same as the processing of step S102 in the flowchart of the training data acquisition according to the first embodiment illustrated in FIG. 11. As described above with reference to FIG. 4, the setting condition table 22a includes a range table.

Next, the AI training data creation support system 1 generates and stores a first query based on the range table (setting condition table 22a) and the personal profile (step S403). Here, the first query is the second supplementary query 1 of the first embodiment that is described with reference to FIG. 13.

Accordingly, in processing of a supplementary query generation subroutine of the third embodiment (see FIG. 12), in processing of generating the second supplementary query 1 to the second supplementary query n, which corresponds to step S203 in the flowchart in FIG. 12, the second supplementary query 2 to the second supplementary query n of the first embodiment are generated, and are set as the second supplementary query 1 to the second supplementary query n−1 of the third embodiment. That is, the second supplementary query 2 to the second supplementary query n of the first embodiment are moved up by one to be the second supplementary query 1 to the second supplementary query n−1 of the third embodiment.

Since processing of steps S404 to S411 in the flowchart illustrated in FIG. 16 is the same as the processing of steps S103 to S110 in the flowchart of the training data acquisition of the first embodiment illustrated in FIG. 11, a description thereof will be omitted.

As described above, in the third embodiment, since the AI training data creation support system 1 generates the first query, the user does not need to create the first query. Accordingly, training data for training an AI model can be efficiently collected.

The invention is not limited to the above-described embodiments and includes various modifications and equivalent configurations within the spirit of the claims. For example, the above-described embodiments are described in detail in order to make the invention easy to understand, and the invention is not necessarily limited to those including all the configurations described above. A part of a configuration of a certain embodiment may be replaced with a configuration of another embodiment. A configuration of another embodiment can be added to a configuration of a certain embodiment. Further, a part of a configuration of each embodiment may be added to, deleted from, or replaced by another configuration.

What is claimed is:

1. An AI training data creation support system for extracting and collecting training data for training an AI model from at least one training database, the AI training data creation support system comprising:
a storage device configured to store at least one program;
a processor configured to execute the program stored in the storage device; and
an input device configured to receive an input from a user, wherein
the processor executes the program to
receive an input of a training profile that includes item values corresponding to a plurality of data items and includes analysis target data to be analyzed by the AI model and information on a type of the AI model,
acquire a first query used for extracting the training data,
calculate, by using the training database, the number of pieces of first training data to be extracted from the training database according to the first query,
calculate the required number of pieces of the training data required to train the AI model, by using the information on the type of the AI model included in the training profile,
determine whether the number of pieces of the first training data is equal to or greater than the required number, and
generate, based on the training profile, a supplementary query used for extracting the training data when the number of pieces of the first training data is determined to be less than the required number.

2. The AI training data creation support system according to claim 1, wherein
the processor generates the first query based on the analysis target data of the training profile.

3. The AI training data creation support system according to claim 1, further comprising:
an output device configured to output the training data, wherein
when the number of pieces of the first training data is determined to be equal to or greater than the required number, the processor extracts the first training data from the training database according to the first query and output the extracted first training data from the output device, and
when the number of pieces of the first training data is determined to be less than the required number, the processor extracts the first training data from the training database according to the first query and outputs the extracted first training data from the output device, and extracts supplementary data from the training database according to the supplementary query and outputs the extracted supplementary data from the output device.

4. The AI training data creation support system according to claim 1, further comprising:
an algorithm required number table configured to store an algorithm of the AI model in association with an algorithm required number indicating the number of pieces of the training data required to train the AI model according to the algorithm; and
an analysis content required number table configured to store analysis content of the AI model in association with an analysis content required number indicating the number of pieces of the training data required to train the AI model according to the analysis content, wherein
the information on the type of the AI model included in the training profile includes information on the algorithm of the AI model and information on the analysis content of the AI model, and
the processor
extracts the algorithm required number from the algorithm required number table by using the information on the algorithm of the AI model included in the training profile,
extracts the analysis content required number from the analysis content required number table by using the information on the analysis content of the AI model included in the training profile, and
calculates the required number based on a larger one between the algorithm required number and the analysis content required number that are extracted.

5. The AI training data creation support system according to claim 1, further comprising:
a statistical coefficient table configured to store one or more data items of the first training data in association with statistical value ranges and statistical coefficients respectively corresponding to the one or more data items, wherein
the processor
calculates, by using the training database, a statistical value of each of the one or more data items of the first training data to be extracted from the training database according to the first query,
extracts, with respect to the calculated statistical value of each of the one or more data items of the first training data, the statistical coefficient corresponding to the statistical value range stored in the statistical coefficient table that includes the calculated statistical value, and
calculates the required number based on the extracted statistical coefficient of each of the one or more data items and the information on the type of the AI model included in the training profile.

6. The AI training data creation support system according to claim 1, further comprising:
a search condition database configured to store a plurality of search condition records in which past analysis target data created in the past and a past query used for extraction of the training data regarding the past analysis target data are associated with each other, wherein
the processor extracts, from the search condition database, at least one search condition record including the past analysis target data whose similarity to the analysis target data of the training profile is larger than a predetermined similarity threshold, and generates at least one first supplementary query based on the past query of the at least one extracted search condition record.

7. The AI training data creation support system according to claim 1, further comprising:
a range table configured to store at least one data item of the analysis target data of the training profile in association with a plurality of item value ranges respectively corresponding to the at least one data item, wherein
the processor generates a plurality of second supplementary queries based on an item value of the analysis target data of the training profile and the plurality of item value ranges of the range table.

8. The AI training data creation support system according to claim 6, further comprising:
domain item information in which a domain item related to the training profile and a domain item range corresponding to the domain item are associated with each other, wherein
the first supplementary query generated by the processor includes the domain item range as a search condition.

9. The AI training data creation support system according to claim 6, wherein
the processor
extracts, from the search condition database, at least one search condition record including the past analysis target data whose similarity to the analysis target data of the training profile is larger than the predetermined similarity threshold, and sets the past query of the at least one extracted search condition record as at least one first supplementary query candidate,
estimates, by using the training database, the number of pieces of first supplementary candidate data to be extracted from the training database according to the first supplementary query candidate,
calculates, as a data number upper limit, a product of a predetermined allowable time interval and a first supplementary data acquisition speed indicating the number of pieces of the first supplementary candidate data that is able to be acquired from the training database per unit time, and
sets, as the first supplementary query, the first supplementary query candidate according to which the number of pieces of the first supplementary candidate data extracted is equal to or less than the data number upper limit value.

10. The AI training data creation support system according to claim 6, further comprising:
an output device configured to output the training data; and
a range table configured to store at least one data item of the analysis target data of the training profile in association with a plurality of item value ranges respectively corresponding to the at least one data item, wherein
the processor
generates a plurality of second supplementary queries based on an item value of the analysis target data of the training profile and the plurality of item value ranges of the range table,
presents the at least one first supplementary query and the plurality of the second supplementary queries to a user by using the output device so that the user can select a supplementary query to be used therefrom,
receives an input of the supplementary query to be used selected by the user,
extracts the first training data from the training database according to the first query, and outputs the extracted first training data by using the output device, and
extracts supplementary data from the training database according to the input supplementary query selected by the user, and outputs the extracted supplementary data by using the output device.

11. The AI training data creation support system according to claim 6, further comprising:
an output device configured to output the training data;
a range table configured to store at least one data item of the analysis target data of the training profile in association with a plurality of item value ranges respectively corresponding to the at least one data item; and
a supplementary query list configured to register the first supplementary query and a second supplementary query as supplementary queries, wherein
the processor
calculates a value obtained by subtracting the number of pieces of the first training data from the required number, and sets the value as a target supplement number,
calculates, by using the training database, the number of pieces of first supplementary data to be extracted from the training database according to the at least one first supplementary query,
generates a plurality of the second supplementary queries based on an item value of the analysis target data of the training profile and the plurality of item value ranges of the range table,
calculates, by using the training database, the number of pieces of second supplementary data to be extracted from the training database according to each of the plurality of generated second supplementary queries,
registers the first supplementary queries of a predetermined number ranking at higher orders in a predetermined priority order, in association with corresponding numbers of pieces of the first supplementary data in the supplementary query list,
registers the second supplementary queries in association with corresponding numbers of pieces of the second supplementary data in the supplementary query list,
repeats a process until a sum of the numbers of pieces of the first supplementary data and the numbers of pieces of the second supplementary data, which are registered in the supplementary query list, is larger than the target supplement number, the process including adding the first supplementary queries of the predetermined number ranking at higher orders in the predetermined priority order, among the first supplementary queries not registered in the supplementary query list, to the supplementary query list together with the corresponding numbers of pieces of the first supplementary data, changing the second supplementary queries registered in the supplementary query list such that a search range corresponding to at least one data item is expanded, calculating the numbers of pieces of the second supplementary data corresponding to the changed second supplementary queries, and replacing the numbers of pieces of the second supplementary data registered in the supplementary query list with the calculated numbers of pieces of the second supplementary data, and
extracts the first training data from the training database according to the first query and outputs the extracted first training data from the output device, and extracts supplementary data from the training database according to the first supplementary queries and the second supplementary queries registered in the supplementary query list and outputs the extracted supplementary data from the output device.

12. The AI training data creation support system according to claim 1, wherein
the AI model is a health care AI model, and the analysis target data includes personal information.

13. An AI training data creation support method to be used in an AI training data creation support system including a storage device configured to store at least one program, a processor configured to execute the program stored in the storage device, and an input device configured to receive an input from a user, the AI training data creation support system extracting and collecting training data for training an AI model from at least one training database, the method comprising:
receiving an input of a training profile that includes item values corresponding to a plurality of data items, and includes analysis target data to be analyzed by the AI model and information on a type of the AI model;
acquiring a first query used for extracting the training data from the training database;
calculating, by using the training database, the number of pieces of first training data to be extracted from the training database according to the first query;
calculating the required number of pieces of the training data required to train the AI model, by using the information on the type of the AI model included in the training profile;
determining whether the number of pieces of the first training data is equal to or greater than the required number; and
generating, based on the training profile, a supplementary query used for extracting the training data when the number of pieces of the first training data is determined to be less than the required number.

14. An AI training data creation support program to be executed by a processor of an AI training data creation support system including a storage device configured to store at least one program, a processor configured to execute the program stored in the storage device, and an input device configured to receive an input from a user, the AI training data creation support system extracting and collecting training data for training an AI model from at least one training database, the program causing the processor to execute:
receiving an input of a training profile that includes item values corresponding to a plurality of data items, and includes analysis target data to be analyzed by the AI model and information on a type of the AI model;
acquiring a first query used for extracting the training data from the training database;
calculating, by using the training database, the number of pieces of first training data to be extracted from the training database according to the first query;
calculating the required number of pieces of the training data required to train the AI model, by using the information on the type of the AI model included in the training profile;
determining whether the number of pieces of the first training data is equal to or greater than the required number; and
generating, based on the training profile, a supplementary query used for extracting the training data when the number of pieces of the first training data is determined to be less than the required number.
